(19) United States
(12) Patent Application Publication
(10) Pub. No.: US 2013/0129511 A1
(43) Pub. Date: May 23, 2013

(54) WIND TURBINE AND APPARATUS AND METHOD FOR DETECTING DAMAGE TO WIND-TURBINE-BLADE SKIN

(71) Applicants: Hiroyuki KAYAMA, Tokyo (JP); Takao KUROIWA, Tokyo (JP); Eiji KATO, Tokyo (JP); Nobuyasu NAKAMURA, Tokyo (JP); Tetsuya SAKIMURA, Tokyo (JP)

(72) Inventors: Hiroyuki KAYAMA, Tokyo (JP); Takao KUROIWA, Tokyo (JP); Eiji KATO, Tokyo (JP); Nobuyasu NAKAMURA, Tokyo (JP); Tetsuya SAKIMURA, Tokyo (JP)

(73) Assignee: MITSUBISHI HEAVY INDUSTRIES, LTD., Tokyo (JP)

(21) Appl. No.: 13/357,231

(22) Filed: Jan. 24, 2012

(30) Foreign Application Priority Data
Nov. 18, 2011 (JP) 2011-252823

(51) Int. Cl. F03D 11/00; G06F 19/00

(52) U.S. Cl. 416/61; 702/35

(57) ABSTRACT

An object is to provide a wind turbine and an apparatus and method for detecting damage to a wind-turbine-blade skin, which can reduce the workload of workers who are in charge of inspection for damage to a wind-turbine-blade skin. Provided is an apparatus for detecting damage to a wind-turbine-blade skin that detects damage to the skin of a wind turbine blade having a hollow structure, the apparatus including a pressure sensor that measures the internal pressure of the wind turbine blade; and a nacelle-side control unit that detects damage based on the pressure measured by the pressure sensor.

### CROSS-REFERENCE TO RELATED APPLICATIONS

This application is based on Japanese Patent Application No. 2011-252823, the contents of which are incorporated herein by reference.

### TECHNICAL FIELD

The present invention relates to a wind turbine and an apparatus and method for detecting damage to a wind-turbine-blade skin.

### BACKGROUND ART

Conventionally, when detecting damage to the skin of a wind turbine blade mounted on a wind turbine, a method in which the operation of the wind turbine is stopped and the skin of the wind turbine blade is actually visually inspected, using an elevated work platform, or a method in which the skin is inspected from the ground using a telescope, has been employed.

### CITATION LIST

### Patent Literature

{PTL 1} Japanese Unexamined Patent Application, Publication No. Hei 8-261135

### SUMMARY OF INVENTION

### Technical Problem

Because these conventional methods involve visual inspection by workers, the workload of workers is high.

An object of the present invention is to provide a wind turbine and an apparatus and method for detecting damage to a wind-turbine-blade skin, which can reduce the workload of workers who are in charge of inspecting for damage to a wind-turbine-blade skin.

### Solution to Problem

To solve the above-described problem, the present invention employs the following solutions.

The present invention provides an apparatus for detecting damage to a wind-turbine-blade skin that detects damage to a skin of a wind turbine blade having a hollow structure, the apparatus including a first pressure-measuring part that measures the internal pressure of the wind turbine blade, and a processing part that detects damage based on the pressure measured by the first pressure-measuring part.

With the present invention, because damage to a wind-turbine-blade skin is detected based on the internal pressures of the plurality of wind turbine blades, the workload of workers is lower than the conventional inspection for skin damage involving visual inspection.

The apparatus for detecting damage to a wind-turbine-blade skin may be applied to a wind turbine having the plurality of wind turbine blades, the first pressure-measuring part may be provided in an inner space of the respective wind turbine blades, and the processing part may detect damage by comparing the pressures measured by the respective first pressure-measuring parts with one another.

Because damage to a wind-turbine-blade skin is detected by comparing the internal pressures of the plurality of wind turbine blades with one another, the workload of workers is lower than the conventional inspection for skin damage involving visual inspection.

In the above-described apparatus for detecting damage to a wind-turbine-blade skin, it is preferable that the processing part calculate, every predetermined first period, average values from the values measured by the first pressure-measuring part and detect damage utilizing the average values, the first period being set longer than the time for the respective wind turbine blades to make one rotation about a rotor shaft.

By utilizing the pressure measurement data averaged every first period, pressure variations due to the rotation of the wind turbine blades can be smoothed out.

In the above-described apparatus for detecting damage to a wind-turbine-blade skin, for example, the processing part may detect damage when the difference between the pressure or an average value of the pressure measured in one wind turbine blade and the pressure or an average value of the pressure measured in another wind turbine blade is greater than or equal to a predetermined value, or when the variation characteristics of the pressure or an average value of the pressure measured in one wind turbine blade differs from the variation characteristics of the pressure or an average value of the pressure measured in another wind turbine blade.

The above-described apparatus for detecting damage to a wind-turbine-blade skin may further include a second pressure-measuring part that measures the external pressure of the wind turbine blade, and a first temperature measuring part that measures the internal temperature of the wind turbine blade. The processing part may detect damage by utilizing an internal and external pressure difference calculated from the pressures measured by the first and second pressure-measuring parts and by utilizing a rate of change of temperature in a predetermined period of time measured by the first temperature measuring part.

The pressure and the temperature are dependent on each other where air-tightness is maintained. However, once air-tightness is lost, their mutual dependence is lost. By detecting damage based on the rate of change of temperature in a predetermined period of time and the internal and external pressure difference using this relationship, damage to the skin can be easily detected.

Although air inevitably flows through molecular-sized small holes even though the internal air-tightness of the wind turbine blade is maintained, by using the relationship between the rate of change of temperature and the internal and external pressure difference, errors due to minor pressure variations can be reduced.

In the above-described apparatus for detecting damage to a wind-turbine-blade skin, the processing part may calculate, every predetermined first period, average values from the respective values measured by the first and second pressure-measuring parts and detect damage by utilizing the average values, the first period being set longer than the time for the wind turbine blades to make one rotation about a rotor shaft.

By utilizing the pressure measurement data averaged every first period, pressure variations due to the rotation of the wind turbine blades can be smoothed out.

In the above-described apparatus for detecting damage to a wind-turbine-blade skin, the processing part may detect damage when an evaluation value determined from the proportion of a rate of change of temperature in a second period that is set longer than the first period, to the internal and external pressure difference at a certain point in time in the second period is beyond a predetermined tolerance range.

The present invention provides a method for detecting damage to a wind-turbine-blade that detects damage to a skin of a wind turbine blade having a hollow structure, the method including measuring the internal pressure of the wind turbine blade; and detecting damage based on the measured pressure.

The present invention provides a wind turbine including any one of the above-described apparatuses for detecting damage to a wind-turbine-blade skin.

### Advantageous Effects of Invention

The present invention has an advantage in that the workload of workers who are in charge of inspecting for damage to a wind-turbine-blade skin can be reduced.

### BRIEF DESCRIPTION OF DRAWINGS

FIG. 1 shows the exterior of a wind turbine according to a first embodiment of the present invention.

FIG. 2 is an enlarged lateral cross-sectional view of a blade root of a wind turbine blade.

FIG. 3 is a schematic block diagram showing the configuration of an apparatus for detecting damage to a wind-turbine-blade skin according to a second embodiment of the present invention.

FIG. 4 is a diagram for explaining a method of calculating an evaluation value.

FIG. 5 is a graph showing the results of a test to assess the effectiveness of an apparatus and method for detecting damage to a wind-turbine-blade skin according to the second embodiment of the present invention.

FIG. 6 is a graph showing the results of a test to assess the effectiveness of the apparatus and method for detecting damage to a wind-turbine-blade skin according to the second embodiment of the present invention.

FIG. 7 is a graph showing the results of a test to assess the effectiveness of the apparatus and method for detecting damage to a wind-turbine-blade skin according to the second embodiment of the present invention.

FIG. 8 is a graph showing the results of a test to assess the effectiveness of the apparatus and method for detecting damage to a wind-turbine-blade skin according to the second embodiment of the present invention.

FIG. 9 is a graph showing the results of a test to assess the effectiveness of the apparatus and method for detecting damage to a wind-turbine-blade skin according to the second embodiment of the present invention.

FIG. 10 is a graph showing the results of a test to assess the effectiveness of the apparatus and method for detecting damage to a wind-turbine-blade skin according to the second embodiment of the present invention.

FIG. 11 is a graph showing the results of a test to assess the effectiveness of the apparatus and method for detecting damage to a wind-turbine-blade skin according to the second embodiment of the present invention.

FIG. 12 is a graph showing the results of a test to assess the effectiveness of the apparatus and method for detecting damage to a wind-turbine-blade skin according to the second embodiment of the present invention.

FIG. 13 is a graph showing the results of a test to assess the effectiveness of the apparatus and method for detecting damage to a wind-turbine-blade skin according to the second embodiment of the present invention.

FIG. 14 is a graph showing the results of a test to assess the effectiveness of the apparatus and method for detecting damage to a wind-turbine-blade skin according to the second embodiment of the present invention.

### DESCRIPTION OF EMBODIMENTS

### First Embodiment

A wind turbine and an apparatus and method for detecting damage to a wind-turbine-blade skin according to a first embodiment of the present invention will be described below with reference to the drawings.

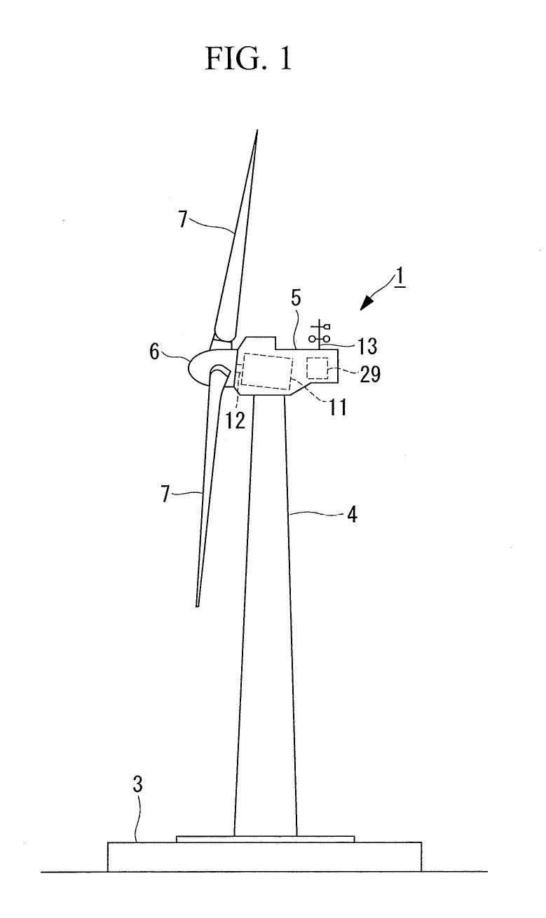

FIG. 1 shows the exterior of a wind turbine 1 according to the first embodiment of the present invention. The wind turbine 1 includes, for example, a tower 4 installed upright on a foundation 3 placed on the ground, a nacelle 5 mounted at the top of the tower 4, and a rotor head 6 mounted on the nacelle 5 so as to be rotatable about a substantially horizontal axis.

A plurality of (for example, three in this embodiment) wind turbine blades 7 are attached to the rotor head 6 radially around the rotation shaft. The wind turbine blades 7, whose pitch angle is variable, are joined to the rotor head 6 so as to be rotatable according to the operation conditions.

The nacelle 5 accommodates a generator 11, and a rotation shaft 12 of the rotor head 6 is joined to a main shaft of the generator 11 via a gearbox (not shown). Therefore, the force of wind blowing against the wind turbine blades 7 is converted into a rotational force for rotating the wind turbine blades 7 and the rotation shaft 12, driving the generator 11 to produce electricity.

The nacelle 5, together with the rotor head 6, can turn horizontally at the top of the tower 4. An anemoscope/anemometer 13 that measures the ambient wind direction and the wind speed is mounted at a certain position on the outer periphery (for example, the top) of the nacelle 5.

The nacelle 5 is controlled to always face upwind by a driving unit and a control unit (not shown) so that electricity can be produced efficiently. Furthermore, the pitch angle of the wind turbine blades 7 is automatically adjusted according to the volume of air so that the wind turbine blades 7 are rotated with maximum efficiency. The nacelle 5 and the wind turbine blades 7 are hollow structures made by, for example, fiber reinforced plastic (FRP) molding.

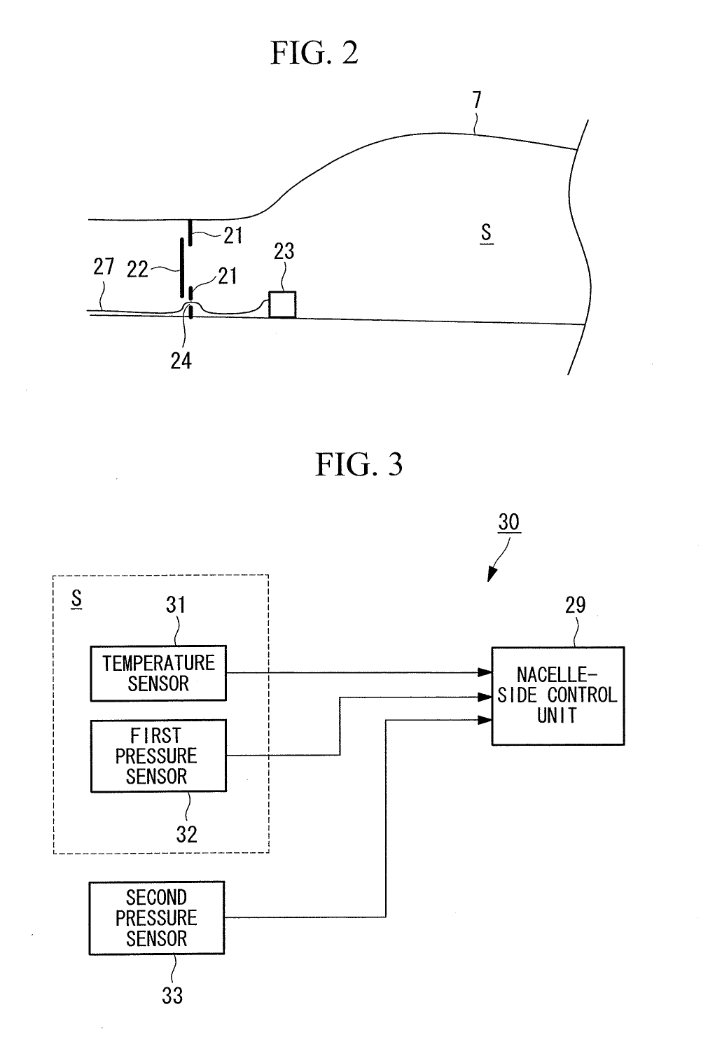

FIG. 2 is an enlarged lateral cross-sectional view of a blade root of the wind turbine blade 7. As shown in FIG. 2, a partition wall 21 having a manhole 22, which can be opened and closed, is provided at the blade root of the wind turbine blade 7. A pressure sensor (first pressure-measuring part) 23 that measures the pressure in an inner space S of the wind turbine blade 7 having a hollow structure is installed in the inner space S. The pressure sensor 23 may be fixed to the partition wall 21 in the wind turbine blade 7, for example.

A harness 27 leading out of the pressure sensor 23 extends to the outside through an opening 24 provided in the partition wall 21 and is connected to a nacelle-side control unit 29 (see FIG. 1) installed, for example, in the nacelle 5. The pressure sensor 23, which is rotated along with the wind turbine blade 7, and the nacelle-side control unit 29, which does not rotate, are electrically connected to each other either by means of wired communication utilizing, for example, a slip ring, or non-contact communication (such as radio communication).

Furthermore, because the partition wall 21 usually has an opening through which a wind-turbine-blade lightning conductor (a down conductor) provided in the inner space S of the wind turbine blade is led out, this opening may be used as the opening 24.

In addition, the wind turbine blade 7 may have a drain (not shown) for discharging water resulting from condensation in the inner space S. The drain can be opened and closed. The drain is provided near the tip of the blade, for example.

The inner space S is a sealed chamber when both the manhole 22 and the drain are closed. The opening 24 is configured to block the flow of air to and from the outside, by using a known member, such as a gasket.

In this wind turbine 1, the pressure sensors 23 provided in the inner spaces S of the wind turbine blades 7 and the nacelle-side control unit 29 constitute an apparatus for detecting damage to the wind-turbine-blade skin.

In this apparatus for detecting damage to the wind-turbine-blade skin, the pressure sensors 23 provided in the inner spaces S of the wind turbine blades 7 measure the pressures in the inner spaces S at predetermined times, and the measurement data are output to the nacelle-side control unit 29.

Upon receipt of the pressure measurement data from the three wind turbine blades 7, the nacelle-side control unit 29 compares the pressure measurement data with one another to determine if there is any damage to the skins of the wind turbine blades.

At this time, if none of the skins of the wind turbine blades 7 are damaged, the measurement results obtained by the pressure sensors 23 show almost the same values because the inner spaces S maintain air-tightness. In contrast, if any of the skins of the wind turbine blades 7 are damaged, the inner space S of that wind turbine blade 7 does not maintain air-tightness, and the internal pressure of that wind turbine blade 7 is lower than the pressures in the inner spaces S of the other wind turbine blades 7.

Accordingly, damage to the skins can be detected by comparing the pressures in the inner spaces S of the wind turbine blades 7 measured at substantially the same time and determining if there is any wind turbine blade 7 that exhibits a specific value with respect to the other wind turbine blades 7.

Although instantaneous values measured by the pressure sensors 23 may be compared with one another at this time, it is more preferable that average values calculated every predetermined first period be compared with one another.

That is, because the skins of the wind turbine blades 7, which are made of FRP, are subjected to cyclically varying load during operation of the wind turbine, the gaseous volumes in the inner spaces S in the wind turbine blades 7 vary. Variations in volume affect the instantaneous values of the pressures. Accordingly, by averaging the measurement data obtained by the pressure sensors 23 installed in the inner spaces S in the wind turbine blades 7 every first period and by comparing the averaged values with one another among the wind turbine blades, the pressure variations caused by the rotation of the wind turbine blades 7 can be smoothed out. Herein, the first period needs to be set longer than the time for the wind turbine blades 7 to make one rotation (the azimuth angle makes a 360° rotation) about the rotor shaft (for example, about 10 minutes).

As has been described, damage detection based on the pressures in the inner spaces S of the wind turbine blades 7 is performed by determining whether or not the pressure in the wind turbine blade in question is exhibiting a specific value with respect to the pressures in the other wind turbine blades. The specific value refers to, for example, a case where the difference between the pressure in the wind turbine blade in question and the pressures in the other wind turbine blades is greater than or equal to a predetermined value, or a case where the wind turbine blade in question is exhibiting pressure-variation characteristics different from those of the other wind turbine blades.

In a two-blade configuration, it is possible to detect that damage occurs in one wind turbine blade, and in a three-blade configuration, it is possible to identify the damaged wind turbine blade, in addition to the occurrence of damage.

When the nacelle-side control unit 29 detects damage to the skin of the wind turbine blade 7, the nacelle-side control unit 29 transmits information to the effect that damage to the skin has been detected and that, if available, which wind turbine blade is damaged to, for example, a ground-side control unit (not shown) provided in the foundation of the tower 4 or provided at a remote location. This communication is performed either via wired communication or via radio communication.

With this configuration, when the ground-side control unit is installed in the foundation of the tower 4, the fact that damage to a wind-turbine-blade skin is detected can be notified to an administrator of the wind turbine who visited the system for inspection, and when the ground-side control unit is provided at a remote location, such as a monitoring center from which the wind turbine is monitored, the fact that damage to the skin of the wind turbine blade 7 is detected can be notified to the monitoring center in real time.

As has been described above, in the wind turbine and the apparatus and method for detecting damage to a wind-turbine-blade skin according to this embodiment, by comparing the internal pressures in a plurality of wind turbine blades to detect damage to a wind-turbine-blade skin, the workload of workers is lower than the conventional skin damage inspection involving visual inspection.

### Second Embodiment

Next, a wind turbine and an apparatus and method for detecting damage to a wind-turbine-blade skin according to a second embodiment of the present invention will be described with reference to the drawings.

In the first embodiment, damage to a wind-turbine-blade skin is detected by comparing the pressures in the inner spaces S of the three wind turbine blades 7 of the wind turbine 1. This embodiment differs from the above-described first embodiment in that damage detection is performed individually on each wind turbine blade and comparison with the other wind turbine blades is not performed.

The wind turbine and the apparatus and method for detecting damage to a wind-turbine-blade skin according to this embodiment will be described below with reference to FIG. 3, taking as an example a case where damage to the skin of one wind turbine blade 7 is to be detected.

FIG. 3 is a schematic block diagram showing the configuration of an apparatus 30 for detecting damage to a wind-turbine-blade skin according to this embodiment. As shown in FIG. 3, the apparatus 30 for detecting damage to a skin is provided in the inner space S in the wind turbine blade 7 and includes a temperature sensor (temperature measuring part) 31 that measures the internal temperature, a first pressure sensor (first pressure-measuring part) 32 that is provided in the inner space S to measure the internal pressure, a second pressure sensor (second pressure-measuring part) 33 that measures the external pressure of the wind turbine blade, and the nacelle-side control unit 29 that detects damage to the skin of the wind turbine blade 7 based on the measurement data from these sensors.

Harnesses leading out of the temperature sensor 31 and the first pressure sensor 32, which are installed in the inner space S in each wind turbine blade 7, extend to the outside through, for example, the opening 24 shown in FIG. 2. The second pressure sensor 33 is provided, for example, on top of the nacelle 5.

Furthermore, the wind turbine blades 7 and the wind turbine 1 according to this embodiment have the same configurations as those according to the first embodiment, and air-tightness in the inner spaces S in the wind turbine blades 7 is maintained.

In the thus-configured apparatus 30 for detecting damage to a wind-turbine-blade skin, the measurement data measured by the temperature sensor 31, the first pressure sensor 32, and the second pressure sensor 33 is output to the nacelle-side control unit 29, and damage to a wind-turbine-blade skin is detected based on the measurement data.

Herein, in a sealed space, the temperature and pressure of gas are proportional to each other, as shown in Expression 1 below. Therefore, if there is no damage to the wind-turbine-blade skin, the pressure in the inner space S changes according to changes in temperature throughout one day.

PV/T=constant (1)

In Expression 1, P is the internal pressure, V is the volume, and T is the temperature.

However, once the wind-turbine-blade skin is damaged and air-tightness is lost, the mutual dependence of the atmospheric temperature and the internal pressure decreases. Therefore, by monitoring the relationship between the atmospheric temperature and the internal pressure, damage to a wind-turbine-blade skin can be detected.

In this embodiment, damage to a wind-turbine-blade skin is detected by monitoring the relationship between the internal and external pressure difference, which is the difference between the pressure in the inner space S of the wind turbine blade 7 and the outside air pressure, and the atmospheric temperature.

More specifically, when the temperature measurement data T(t), the internal pressure measurement data P1(t), and the external pressure measurement data P2(t) are input from the temperature sensor 31, the first pressure sensor 32, and the second pressure sensor 33, respectively, the nacelle-side control unit 29 calculates their average values every first period. Herein, as mentioned above, the first period is set longer than the time for the wind turbine blades 7 to make one rotation (the azimuth angle makes a 360° rotation) about the rotor shaft.

Then, the nacelle-side control unit 29 calculates an evaluation value using the averaged measurement data. An evaluation value, Q, is determined based on, for example, the rate of change of temperature in a second period, which is longer than the first period, and the internal and external pressure difference at a certain point in time in the second period. For example, the evaluation value Q is expressed by the proportion of the rate of change of temperature in the second period to the internal and external pressure difference at a certain point in time in the second period, and is given by Expression 2 below.

Q=ΔP/(dT/dt) (2)

In Expression 2 above, ΔP is the internal and external pressure difference at a certain point in time in the second period, and dT/dt is the rate of change of temperature in the second period. A greater evaluation value Q means higher air-tightness, and a smaller evaluation value Q means lower air-tightness.

The nacelle-side control unit 29 calculates the evaluation value Q for each wind turbine blade 7 and detects damage to the skin when the evaluation value Q exhibits a specific behavior. The specific behavior refers to, for example, a case where the evaluation value Q is lower than a predetermined threshold.

When damage to the skin of the wind turbine blade 7 is detected, this fact is transmitted to the ground-side control unit, similarly to the above-described first embodiment.

Note that, in this embodiment, the temperature sensor 31 and the first pressure sensor 32 are installed in the inner space S of each wind turbine blade 7. The second pressure sensor 33 may be either installed in each wind turbine blade 7 or shared by three wind turbine blades 7.

As has been described above, in the wind turbine and the apparatus and method for detecting damage to a wind-turbine-blade skin according to this embodiment, because the evaluation value Q is calculated for each wind turbine blade 7 utilizing the temperature in the inner space S and the pressure difference, and damage to a wind-turbine-blade skin is detected based on the evaluation value Q, the workload of workers is lower than the conventional skin damage inspection involving visual inspection. Furthermore, because detection of damage to the skin is performed individually on each wind turbine blade, the damaged wind turbine blade can be identified regardless of the number of wind turbine blades.

Although air inevitably flows through molecular-sized small holes even though air-tightness inside the wind turbine blade is maintained, by using the relationship between the rate of change of temperature and the internal and external pressure difference, such as the evaluation value Q, errors due to minor pressure variations can be reduced.

To study the effectiveness of the apparatus and method for detecting damage to a wind-turbine-blade skin according to the second embodiment, the inventors conducted the following test.

In this test, a wind turbine blade A having no damage, a wind turbine blade B with a tube having a diameter of 1 mm penetrating the skin, and a wind turbine blade C with a tube having a diameter of 4 mm penetrating the skin were placed on the ground, and the temperatures and pressures of the inner spaces S of these wind turbine blades and the external pressures were measured. Temperature sensors were provided at three positions, specifically, 0 m, 10 m, and 20 m, from the blade root to the blade tip. A temperature sensor provided on the blade surface to measure the blade surface temperature and a temperature sensor for measuring the outer atmospheric temperature were also provided.

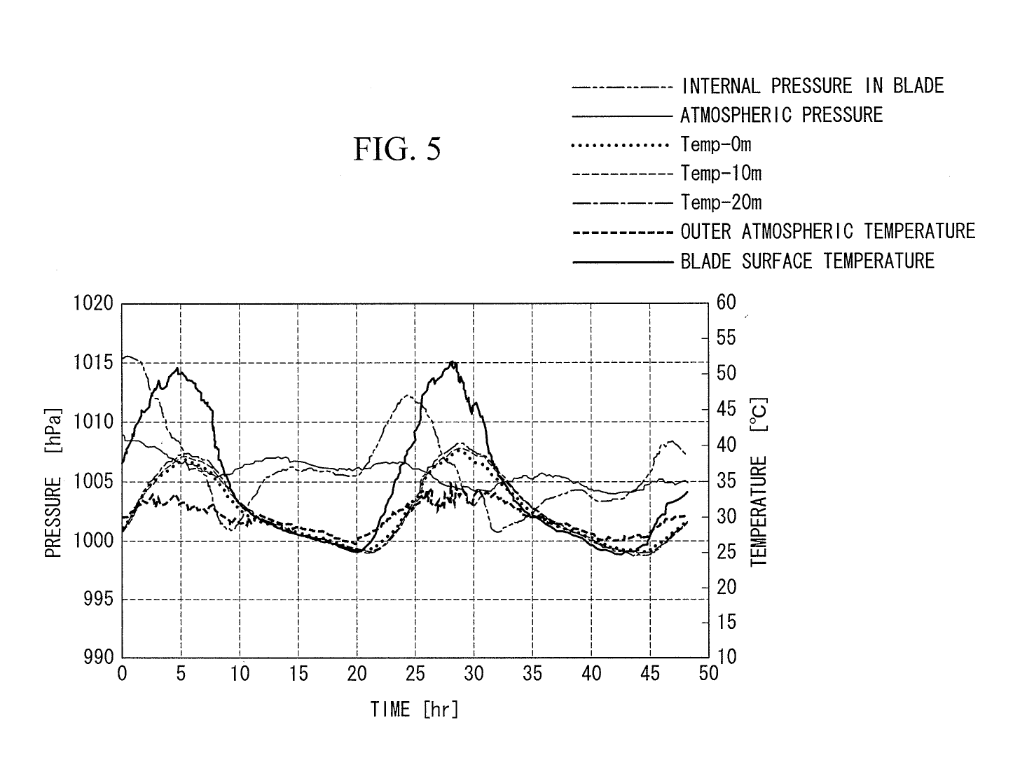

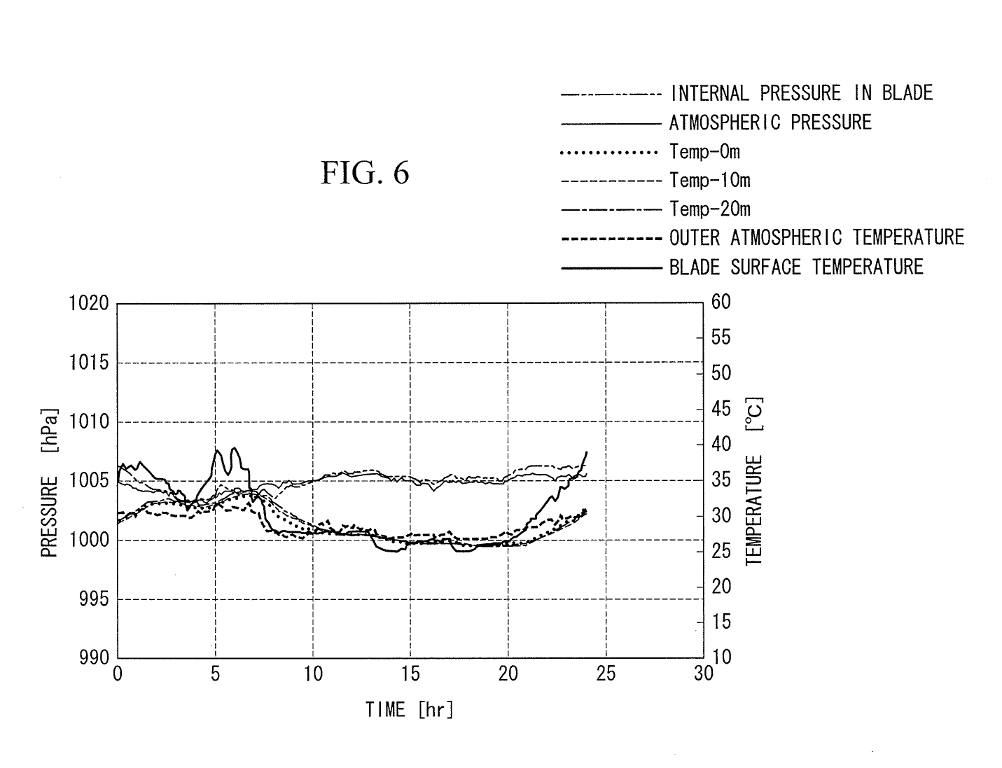

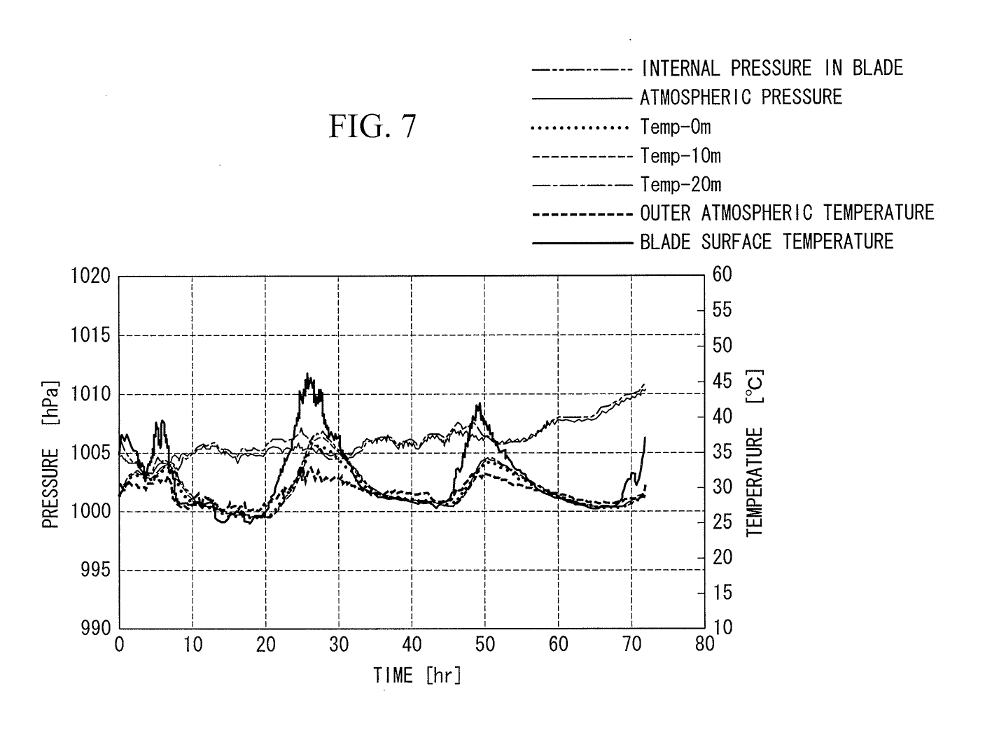

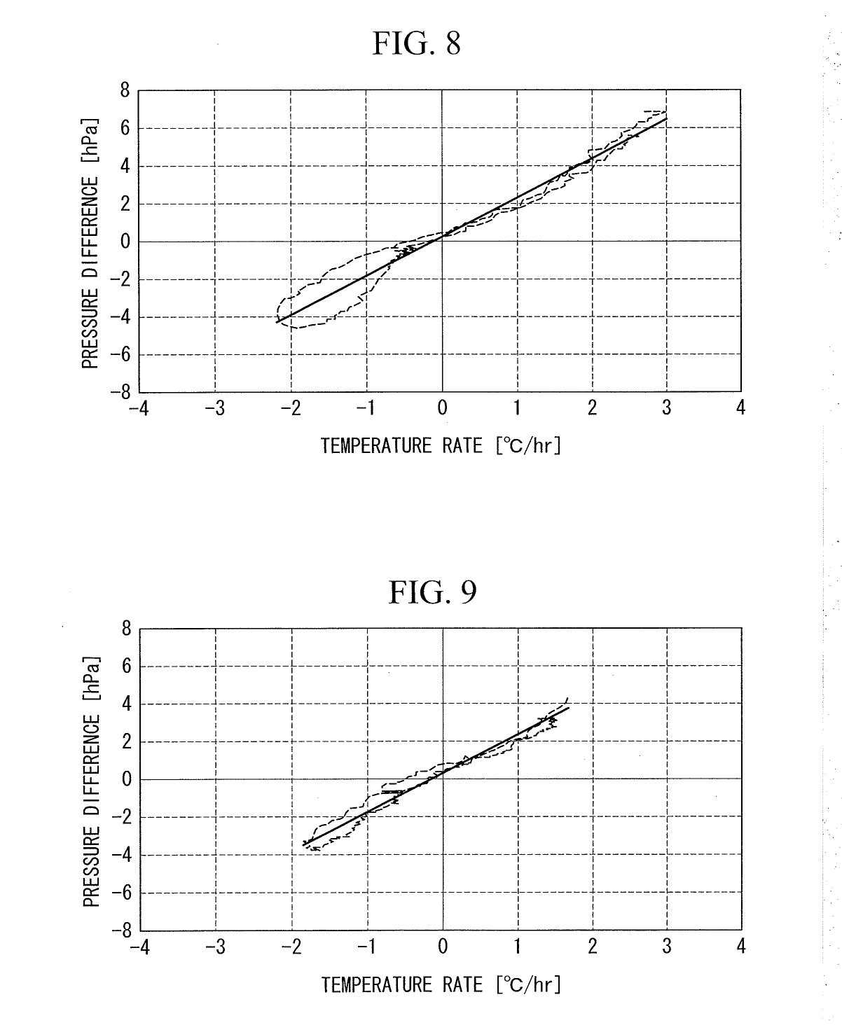

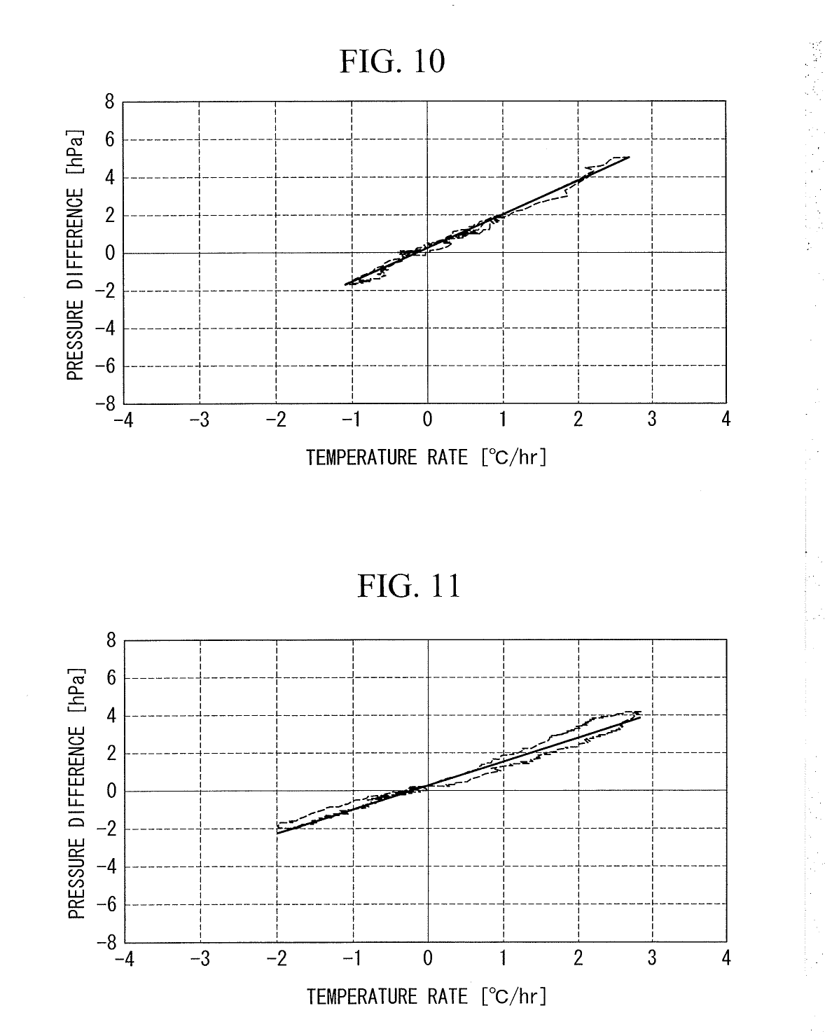

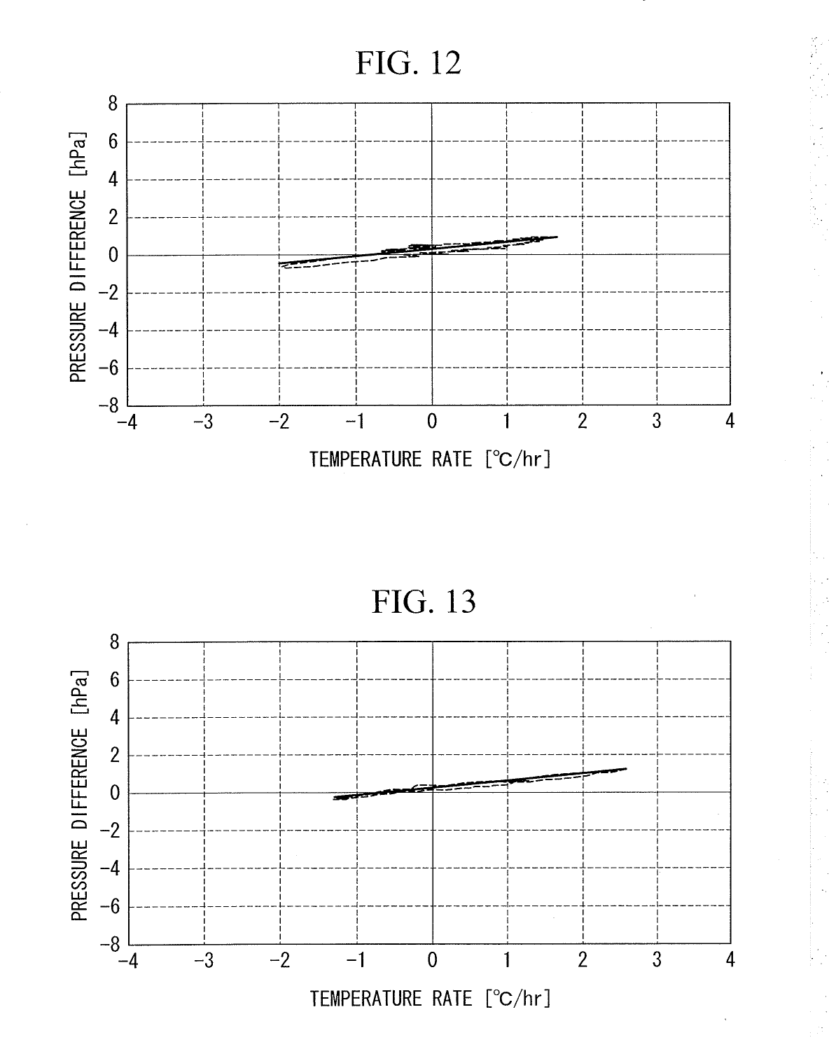

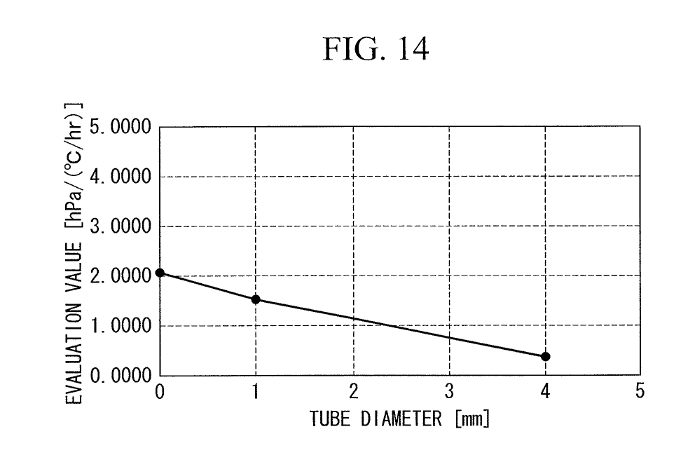

FIG. 5 shows the measurement data for the wind turbine blade A on Day 1, FIG. 6 shows the measurement data for the wind turbine blade B on Day 1, and FIG. 7 shows the measurement data for the wind turbine blade C on Day 1. FIG. 8 shows the relationship between the rate of change of temperature (hereinbelow, “temperature rate”) and the internal and external pressure difference (hereinbelow, “pressure difference”) for the wind turbine blade A on Day 1 of the experiment, and FIG. 9 shows the relationship between the temperature rate and the pressure difference for the wind turbine blade A on Day 2. Similarly, FIGS. 10 and 11 show the relationship between the temperature rate and the pressure difference for the wind turbine blade B on Day 1 and Day 2 of the experiment, and FIGS. 12 and 13 show the relationship between the temperature rate and the pressure difference for the wind turbine blade C on Day 1 and Day 2 of the experiment. Note that, in FIGS. 8 to 13, the measurement data averaged every five minutes were used, and approximated curves were obtained from the measurement data.

The evaluation values Q for the wind turbine blades A, B, and C on Day 1 and Day 2 obtained from the test results shown in FIGS. 8 to 13, in other words, the inclinations of the approximated curves in FIGS. 8 to 13, are shown in Table 1.

TABLE 1

| WIND | DIAMETER | SEC- | EVALUATION VALUE | | |
|---|---|---|---|---|---|
| TURBINE | OF TUBE | TIONAL | [hPA/(° C./hr)] | | |
| BLADE | [mm] | AREA [mm] | DAY 1 | DAY 2 | AVERAGE |
| A | 0 | 0 | 2.0627 | 2.0661 | 2.0644 |
| B | 1 | 0.7854 | 1.7707 | 1.2634 | 1.5171 |
| C | 4 | 12.5664 | 0.3765 | 0.3732 | 0.3749 |

The graph in FIG. 14 is obtained by showing the results in Table 1 above in a coordinate space, plotting the tube diameter [mm] on the horizontal axis and the evaluation value Q on the vertical axis.

It can be seen from above that, even when damage with a size of from about 1 mm to 4 mm is caused, the damage can be detected within several days from the time the damage is caused.

Although the evaluation values Q were calculated using the Expression 2 above in this embodiment, damage to the skin may be detected by using evaluation value a obtained by Expression 3 below instead.

The evaluation value a is determined based on, for example, the change in temperature in the second period and the change in the internal and external pressure difference in the second period. For example, the evaluation value a is expressed by the proportion of the change in temperature in the second period to the change in the internal and external pressure difference in the second period, and is given by Expression 3 below.

α=ΔP/ΔT={P(th)−P(te)}/{T(th)−T(te)} (3)

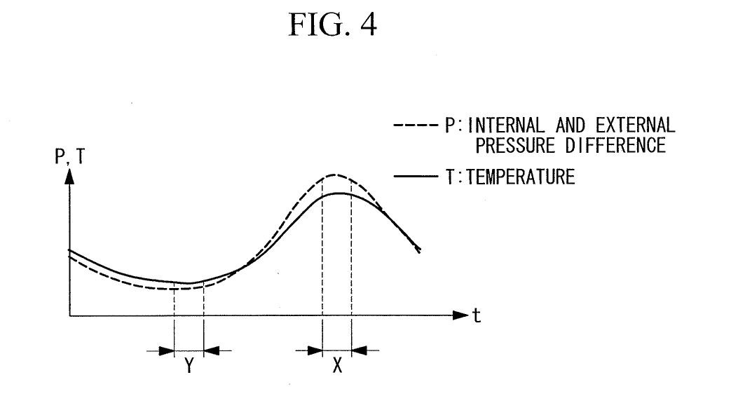

Here, as shown in FIG. 4, T(th) is the average temperature data in a time period X when the atmospheric temperature is highest in a day (for example, from 11 A.M. to 1 P.M.), T(te) is the average temperature data in a time period Y when the atmospheric temperature is lowest in a day (for example, from 3 A.M. to 5 A.M.). Furthermore, P(th) is the average pressure difference corresponding to T(th), and P(te) is the average pressure difference corresponding to T(te).

The nacelle-side control unit 29 calculates the evaluation value α for each wind turbine blade 7 day by day, and detects damage to the skin when the evaluation value α exhibits a specific behavior. The specific behavior refers to, for example, a case where the evaluation value α exceeds a predetermined tolerance.

### REFERENCE SIGNS LIST

1 wind turbine
5 nacelle
6 rotor head
7 wind turbine blade
11 generator
12 rotation shaft
21 partition wall
22 manhole
23 pressure sensor
29 nacelle-side control unit
30 apparatus for detecting damage to a wind-turbine-blade skin
31 temperature sensor
32 first pressure sensor
33 second pressure sensor

1. An apparatus for detecting damage to a wind-turbine-blade skin that detects damage to a skin of a wind turbine blade having a hollow structure, the apparatus comprising:
a first pressure-measuring part that measures the internal pressure of the wind turbine blade; and
a processing part that detects damage based on the pressure measured by the first pressure-measuring part.

2. The apparatus for detecting damage to a wind-turbine-blade skin according to claim 1, wherein
the apparatus for detecting damage to a wind-turbine-blade skin is applied to a wind turbine having the plurality of wind turbine blades,
the first pressure-measuring part is provided in an inner space of the respective wind turbine blades, and
the processing part detects damage by comparing the pressures measured by the respective first pressure-measuring parts with one another.

3. The apparatus for detecting damage to a wind-turbine-blade skin according to claim 2, wherein the processing part calculates, every predetermined first period, average values from the values measured by the first pressure-measuring part and detect damage utilizing the average values, the first period being set longer than the time for the respective wind turbine blades to make one rotation about a rotor shaft.

4. The apparatus for detecting damage to a wind-turbine-blade skin according to claim 1, wherein the processing part detects damage when the difference between the pressure or an average value of the pressure measured in one wind turbine blade and the pressure or an average value of the pressure measured in another wind turbine blade is greater than or equal to a predetermined value, or when the variation characteristics of the pressure or an average value of the pressure measured in one wind turbine blade differs from the variation characteristics of the pressure or an average value of the pressure measured in another wind turbine blade.

5. The apparatus for detecting damage to a wind-turbine-blade skin according to claim 1, further comprising:
a second pressure-measuring part that measures the external pressure of the wind turbine blade; and
a first temperature measuring part that measures the internal temperature of the wind turbine blade,
wherein the processing part detects damage by utilizing an internal and external pressure difference calculated from the pressures measured by the first and second pressure-measuring parts and by utilizing a rate of change of temperature in a predetermined period of time measured by the first temperature measuring part.

6. The apparatus for detecting damage to a wind-turbine-blade skin according to claim 5, wherein the processing part calculates, every predetermined first period, average values from the respective values measured by the first and second pressure-measuring parts and detects damage by utilizing the average values, the first period being set longer than the time for the wind turbine blades to make one rotation about a rotor shaft.

7. The apparatus for detecting damage to a wind-turbine-blade skin according to claim 6, wherein the processing part detects damage when an evaluation value determined from the proportion of a rate of change of temperature in a second period that is set longer than the first period, to the internal and external pressure difference at a certain point in time in the second period is beyond a predetermined tolerance range.

8. A method for detecting damage to a wind-turbine-blade that detects damage to a skin of a wind turbine blade having a hollow structure, the method comprising:
measuring the internal pressure of the wind turbine blade; and
detecting damage based on the measured pressure.

9. A wind turbine comprising the apparatus for detecting damage to a wind-turbine-blade skin according to claim 1.
